(19) United States
(12) Patent Application Publication
(10) Pub. No.: US 2025/0332749 A1
(43) Pub. Date: Oct. 30, 2025

(54) UNIVERSAL TOOL DEVICE

(71) Applicant: Yves SYRKOS, Blainville (CA)

(72) Inventor: Yves SYRKOS, Blainville (CA)

(21) Appl. No.: 19/177,756

(22) Filed: Apr. 14, 2025

Related U.S. Application Data
(60) Provisional application No. 63/719,339, filed on Nov. 12, 2024.

(51) Int. Cl. B26B 13/28

(52) U.S. Cl. CPC B26B 13/28

(57) ABSTRACT

A universal tool device for working out an object including first and second working members pivotally connecting to one another about a main axis and being adapted to simultaneously work the object therebetween. First and second handle members pivotally connect to one another about a handle axis intersecting the main axis at least at an intersection point between the working members. The handle members connect to the working members, respectively, via a connecting member allowing a selective angular positioning about the main axis between the handle members and the respective working members. A retaining member selectively retains the handle members and the respective working members connected to one another along the main axis. Optionally, the handle axis is angularly spaced relative to the main axis to define a lateral angle therebetween, and the intersection point is a midpoint between the working members.

### CROSS-REFERENCE TO RELATED APPLICATIONS

The present application claims the benefit of U.S. provisional patent application No. 63/719,339, filed on Nov. 12, 2024.

### TECHNICAL FIELD OF THE INVENTION

The present disclosure relates to tool devices, and more specifically, to a universal and adjustable tool device with a pair of handles for working out an object.

### BACKGROUND OF THE INVENTION

Traditional handheld tools, such as scissors, shears, trimmers, snips, pliers, or specialized tools (for use in dentistry or the like) and the like, used for working out an object, are typically made for either right-handed users or left-handed users, but not for both. Additionally, typical hand working tools are made with a single format for a single type of use, such as conventional scissors that are made for cutting materials (plastic sheets, paper, carboard, etc.) or the ones that are angled for better cutting of tissues, liners, etc. laid on a horizontal surface.

Furthermore, some specialized tools which are made with a specific shape for a predetermined use, such as in pliers in dentistry, or the like for medical/surgical purpose, would sometimes need to be modified for use in a different use or simply to reach a different object, and in such cases different tools are therefore used (as the original ones are not adaptable).

Accordingly, there is a need for an improved universal tool device for working out an object.

### SUMMARY OF THE INVENTION

It is therefore a general object of the present disclosure to provide a universal tool device for working out an object that obviates the above-noted drawbacks and problems.

An advantage of the present invention is that the tool device is adaptable to provide different angles, typically predetermined, between the pair of working members and the pair of handles, about the pivoting (main) axis of the working members.

Another advantage of the present invention is that the tool device is usable by any user, being right-handed or left-handed.

A further advantage of the present invention is that the tool device may also further allow for a transversal (lateral) angle, at predetermined positions or angles, between the working members and the handles (which could be advantageous especially when using snips-type working members and the like), both having different rotational axes typically intersecting one another at a midpoint between the two working members.

Yet another advantage of the present invention is that the tool device allows for interchangeable types of working members, with a same pair of handles, such as scissors, pliers, shears, etc.

According to an aspect of the present disclosure there is provided a universal tool device, the device comprising:
first and second working members pivotally connecting to one another about a main axis (between fully open and closed configurations), the first and second working members being adapted to simultaneously work the object therebetween;
first and second handle members pivotally connecting to one another about a handle axis intersecting the main axis at least at an intersection point between the first and second working members, the first and second handle members connecting to the first and second working members, respectively, via a connecting member, the connecting member allowing a selective angular positioning about the main axis between the first and second handle members and the respective first and second working members; and
a retaining member selectively retaining the first and second handle members and the respective first and second working members connected to one another along the main axis.

In one embodiment, the first and second handle members removably connecting to the first and second working members, respectively.

Conveniently, the handle axis being colinear with the main axis.

Conveniently, the first and second working members being removably connected to one another.

In one embodiment, the first and second working members including a guide mechanism allowing the first and second working members to pivot relative to one another about the main axis between a fully open configuration, in which the first and second working members are adapted to receive the object therebetween, and a closed configuration, in which the first and second working members abut to one another with no object therebetween.

Conveniently, the tool device further includes a securing mechanism axially securing the first and second working members to one another along the main axis while allowing the first and second working members to pivot relative to one another about the main axis.

In one embodiment, the guide mechanism includes a symmetrical pin and slot arrangement with a slot portion being arcuate about the main axis for slidably receiving a respective pin portion therealong.

In one embodiment, the securing mechanism including a tab member radially protruding from the respective pin portion for engaging a recess member radially extending from the respective slot portion.

In one embodiment, the connecting member includes a pin part extending from each said first and second handle members toward the other one said first and second handle members engaging a corresponding hole part extending into each said first and second working members, each said pin part axially extending along the handle axis and each said hole part axially extending along the main axis.

Conveniently, each said pin part and said hole part having a generally axial elongated body (polygonal prism) and corresponding and recess, respectively, with a transversal section area of a polygonal shape.

Conveniently, the polygonal shape is one of a triangular, a square, an hexagonal, an heptagonal, an octagonal, a nonagonal, a decagonal, an hendecagonal, a dodecagonal, an hexadecagonal, an icosagonal, and a icositetragonal shape.

In one embodiment, the retaining member includes a rod member extending from one said first and second handle members towards the other one said first and second handle members, and a lock member located at a free end of the rod member releasably securing to the other one said first and second handle members.

Conveniently, the rod member extends along the main axis and through the first and second working members.

Conveniently, the lock is a circumferential slot extending radially inwardly at the free end of the rod member and being selectively engageable by a locking tab member movably mounted on the other one said first and second handle members.

In one embodiment, the handle axis is angularly spaced relative to the main axis, thereby defining a lateral (shift-transversal) angle therebetween, and the intersection point is a mid-point between the first and second working members.

Conveniently, the connecting member allows for translational and/or rotational displacement between the first and second handle members and the respective first and second working members connected thereto.

Conveniently, the connecting member includes a pin part extending from each said first and second handle members toward the other one said first and second handle members engaging a corresponding hole part extending into each said first and second working members, each said pin part axially extending along the handle axis and each said hole part axially extending along the main axis.

Conveniently, each said pin part and said hole part tapering down in a direction extending toward the intersection point.

Other objects and advantages of the present invention will become apparent from a careful reading of the detailed description provided herein, with appropriate reference to the accompanying drawings.

### BRIEF DESCRIPTION OF THE DRAWINGS

Embodiments of the disclosure will be described by way of examples only with reference to the accompanying Figures, with similar references referring to similar components, in which:

FIG. 1 is a schematic front view of a universal, and typically adjustable tool device in accordance with an embodiment of the present invention, showing the pair of working members, such as scissors, adjustable in different coplanar angular positions relative to the handle members;

FIG. 2 is a schematic top plan view of the tool device of FIG. 1;

FIG. 3 is a schematic partial front view of another embodiment of pair of working members, such as pliers, to be usable with the tool device of FIG. 1;

FIG. 4 is a schematic partially broken enlarged exploded left side section view of the attachment mechanism of the working members of the tool device, taken along line 4-4 of FIG. 1, showing;

FIG. 5 is a schematic partially broken front view taken along line 5-5 of FIG. 4, showing the portion of the connecting member located on the working member;

FIG. 6 is a schematic partially broken rear view taken along line 6-6 of FIG. 4, showing the guide mechanism of the working member;

FIG. 7 is a schematic enlarged exploded left side view of the tool device of FIG. 1, showing the retaining member releasably connecting the handle members to one another with the pair of working members there between;

FIGS. 8A and 8B are schematic enlarged partial front views of the retaining member of the tool device of FIG. 1, in the unlocking and locking configurations, respectively;

FIG. 9 is a schematic top view of the handle member on the right-hand-side of FIG. 7, showing the retaining member;

FIG. 10 is a schematic rear view taken along line 10-10 of FIG. 9, showing the portion of the connecting member located on the handle member;

FIG. 11 is a schematic top view of a universal, and typically adjustable tool device in accordance with another embodiment of the present invention, showing the pair of working members, such as scissors, adjustable in different lateral (out-of-plane) angular positions relative to the handle members;

FIG. 12 is a schematic enlarged top view of the portion of the connecting member located on the lower side of the tool device of FIG. 11, showing a plurality of different lateral (out-of-plane) angular positions of the connecting member;

FIG. 13 is a schematic partially broken front view taken along line 13-13 of FIG. 12, showing the plurality of different lateral (out-of-plane) angular positions of the connecting member;

FIG. 14 is a schematic enlarged top view of the portion of the retaining member located on the connecting member of the lower side of the tool device of FIG. 11; and

FIG. 15 is a schematic partially broken rear view taken along line 15-15 of FIG. 14, showing the portion of the connecting member located on the handle member.

### DETAILED DESCRIPTION OF THE INVENTION

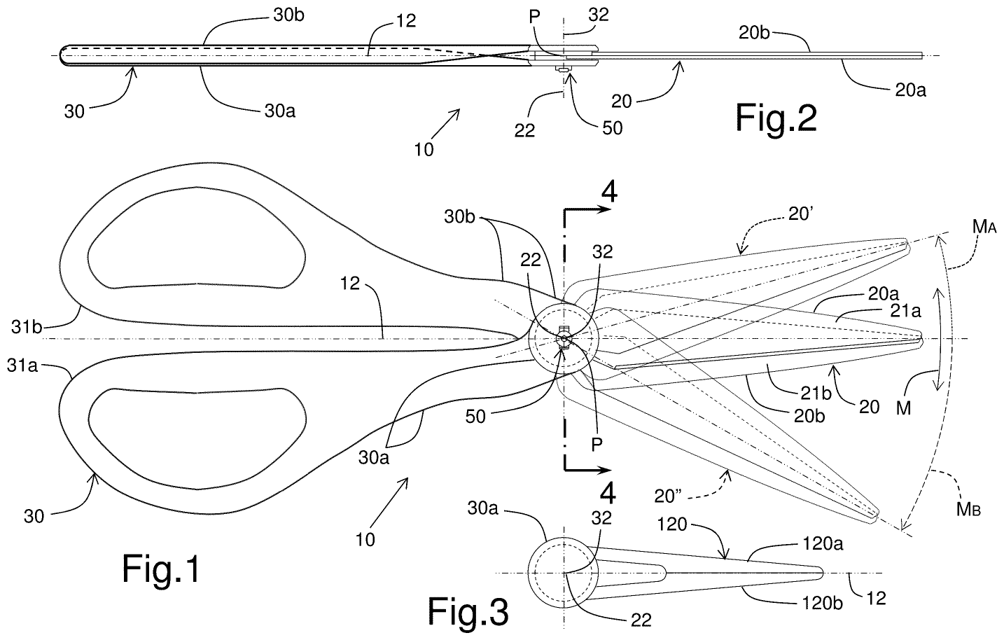

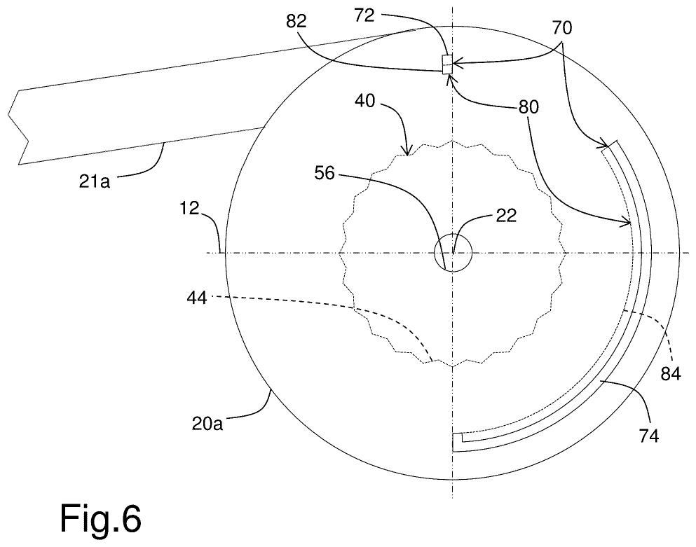

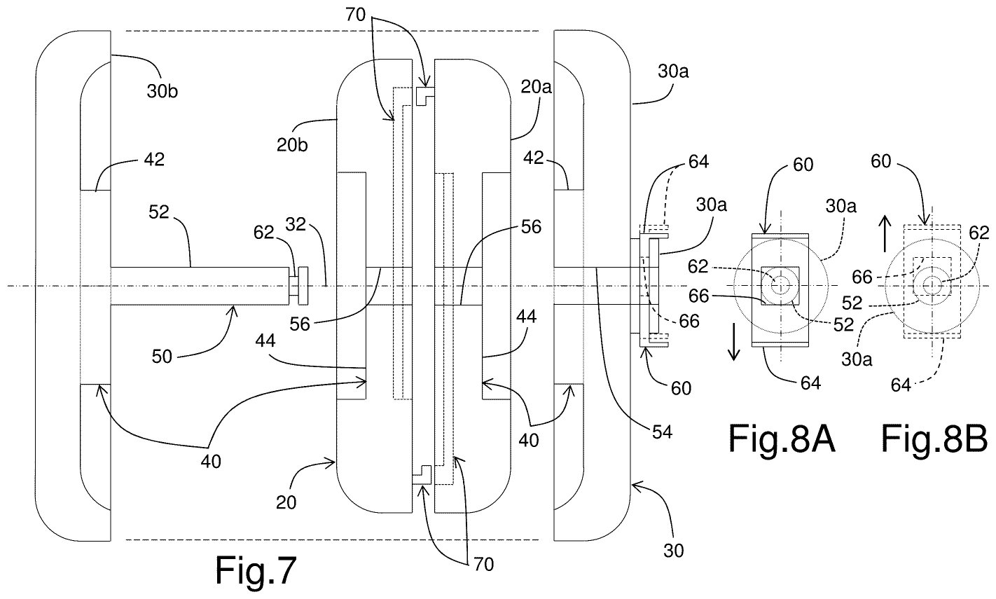

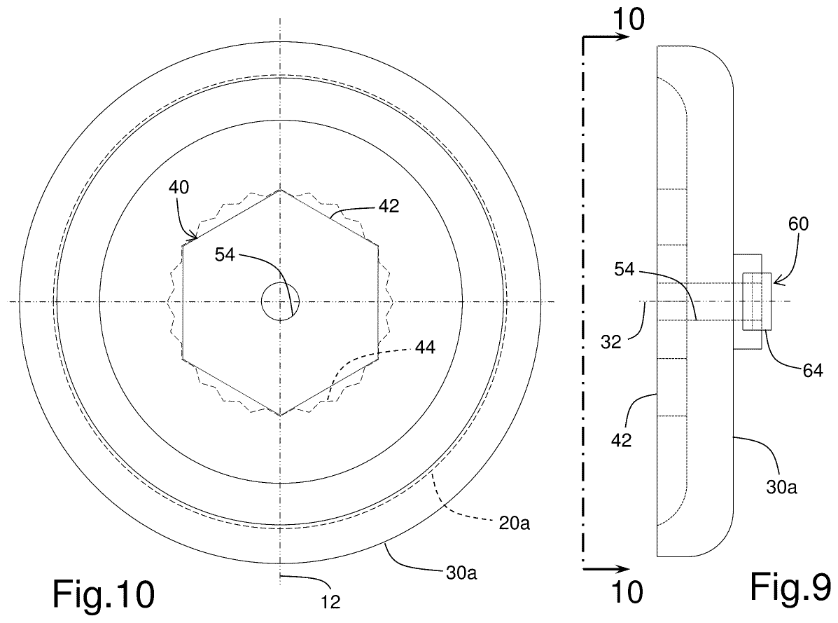

Referring to FIGS. 1 to 10, there is shown an embodiment of a universal, and typically adjustable, tool device 10 in accordance with the present invention. The tool device 10, defining a longitudinal axis 12, is used for working out an object (not shown), and comprises a pair of or first and second working (tool) members 20 (such as scissors—shown in FIGS. 1-2 and 4-10, shears, trimmers, snips, pliers 120—shown in FIG. 3, or field specialized (dentistry or medical field) and the like) pivotally connecting to one another about a main axis 22 between fully open (when positioning the device relative to the object) and closed (when working the object therebetween) configurations, and any intermediate open configuration there between. The first 20a, 120a and second 20b, 120b working members 20, 120, with respectively the first 21a and second 21b working tool section themselves, are adapted to simultaneously work the object therebetween. First 30a and second 30b handle members 30, with respectively the first 31a and second 31b handle section themselves, pivotally connect to one another about a handle axis 32 intersecting the main axis 22 least at an intersection point P between the first and second working members 20. The first and second handle members 30 typically removably connect to the first and second working members 20, respectively, via a connecting member 40. As best seen in FIG. 1, the connecting member 40 allows a selective angular, defined as main angle M, positioning about the main axis 22 between the first and second handle members 30 and the respective first and second working members 20, for example, with the pair of working members 20′ being angularly moved upward (or counter-clockwise—also represented with the long-dash-line hexagon in FIG. 5) by main angle M_{A} of about 15°, or with the pair of working members 20″ being angularly moved downward (or clockwise—also represented with the short-dash-line hexagon in FIG. 5) by main angle M_{B} of about 30° relative to the pair of handle members 30. The connecting member 40 allows the pair of working members 20 to be typically interchangeable with another pair, while keeping the same pair of handle members 30. A retaining member 50 selectively retains the first 20a and second 20b handle members 30 and the respective first 30a and second 30b working members 20 connected to one another along the main axis 22.

As illustrated more specifically in FIGS. 1-3, 5, 7 and 10, the handle axis 32 is typically colinear with the main axis 22, and the first and second working members 20 are typically removably connected to one another.

Typically, the first and second working members 20 include a guide mechanism 60 allowing the first and second working members 20 to typically slidably pivot relative to one another about the main axis 22 between the open, in which the tool portion of the first and second working members 20 are spaced apart from one another (no abutment or touching) and adapted to receive or position the object therebetween, and closed, in which the tool portion of the first and second working members 20 abut to one another with no object therebetween, configurations, respectively.

Typically, the connecting member 40 includes a pin part 42 extending from each said first and second handle members 30 toward the other one said first and second handle members 30 to engage a corresponding hole part 44 extending into each said first and second working members 20. Each pin part 42 axially extends along the handle axis 32 and each hole part 44 axially extends along the main axis 22.

Each pin part 42 preferably has a generally axial elongated body (polygonal prism) with a transversal section area of a polygonal shape (preferably square, as illustrated by pin part 142 of FIG. 5, or hexagonal shape 42, 42′, 42″), and each hole part 44 preferably has a corresponding generally axial elongated recess (polygonal prism) with a corresponding transversal section area of the polygonal shape to tightly removably receive the pin part 42 therein. The polygonal shape is typically one of a triangular (3), a square (4), an hexagonal (6), an heptagonal (7), an octagonal (8), a nonagonal (9), a decagonal (10), an hendecagonal (11), a dodecagonal (12), an hexadecagonal (16), an icosagonal (20), and a icositetragonal (24) shape, and preferably a icositetragonal shape as illustrated in the figures. As best seen in FIG. 5, the hexagonal-shape pin part 42 is inserted into the corresponding icositetragonal-shape hole part 44, with the hexagonal-shape pin part 42, 42′, 42″ shown either in solid lines, short-stippled lines, or long-stippled lines with the working members 20, 20′, 20″ extending “in-line” (horizontal), or angularly upward, or angularly downward relative to the handle members 30, respectively, in the positions shown in FIG. 1.

Obviously, although not specifically illustrated herein, a person skilled in the art would readily understand that many other types of connecting member 40 or other shapes and/or combination of shapes are possible without departing from the scope of the present invention. For example, the pin part 42 could have a square shape while the hole part 44 could have a dodecagonal shape. Also, the pin part 42 could have a relatively flat plate shape (as a flat shape screwdriver), or diametrically spaced apart pins, while the hole part 44 could have a star shape with an even number of multiple corresponding star points or pin holes.

Although a person skilled in the art would readily understand that many types of different retaining members 50 are possible without departing from the scope of the present invention, as best seen in FIGS. 1 and 7-9, the retaining member 50 of the illustrated embodiment 10 typically includes a rod 52 extending along the handle axis 32 from the second handle member 30b toward and into a rod receiving hole 54 of the first handle member 30a. The rod 52 typically extends through respective holes 56 of the first and second working members 20 to retain the working members 20 between the handle members 30. The retaining member 50 also typically includes a lock 60 that releasably locks the handle members 30 to each other, Although the lock 60 can take many forms or shapes (such as, for example a snap fastener or the like), the illustrated lock 60 typically takes the form of a circumferential slot 62 extending radially inwardly at the free end of the rod 52 and adapted to be at least partially engageable by a locking tab 64 movably mounted on the first handle member 30a, the locking tab 64 having an opening 66 extending therethrough and sized to selectively clear the diameter of the rod 52, and being slidably movable between a rod releasing position (when slid in the lower position—see FIG. 8A) and a rod retaining position (when slid in the upper position—see FIG. 8B), as schematically illustrated in FIGS. 8A and 8B, respectively.

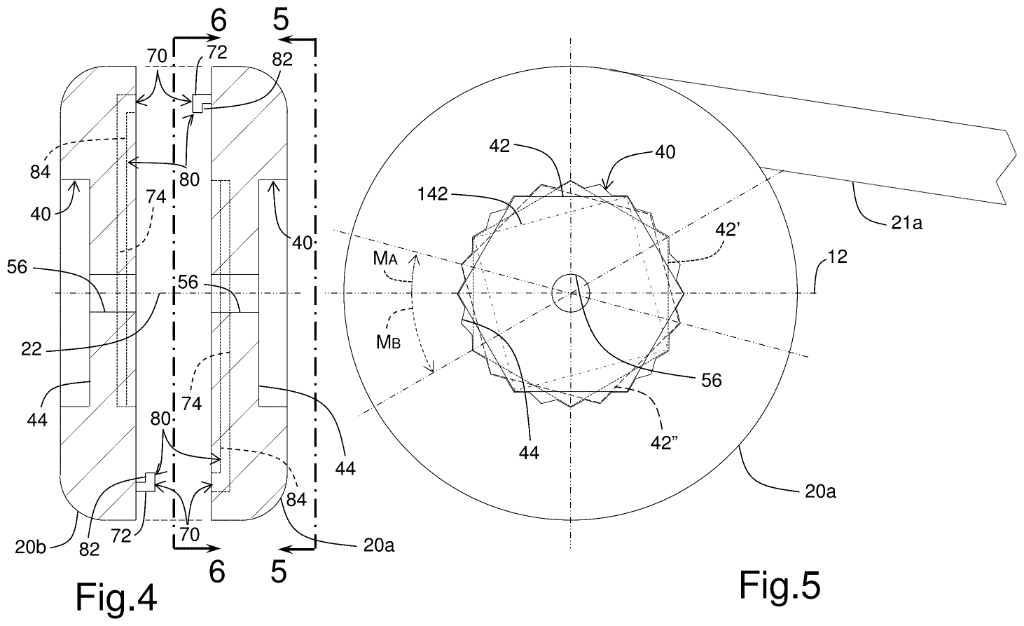

In the embodiment 10, as best seen in FIGS. 4, 6, and 7, the illustrated guide mechanism 70 includes a typically symmetrical pin 72 and slot 74 arrangement with a slot portion 74 being arcuate about the main axis 22 that slidably receives a respective corresponding pin portion 72 there along between the fully open and closed configurations.

Preferably, the device 10 further includes a securing mechanism 80 axially securing the first 20a and second 20b working members 20 to one another along the main axis 22 while allowing the first and second working members 20 to pivot relative to one another about the main axis 22.

In the embodiment 10, again as best seen in FIGS. 4, 6, and 7, the illustrated securing mechanism 80 preferably includes a tab member 82 radially protruding inwardly from the respective pin portion 72 for engaging a corresponding recess member 84 radially extending inwardly from the respective slot portion 74. Typically, the securing mechanism 80 further enables the first and second working members 20 to unsecure or disconnect from one another, such as when the fully open configuration in which the tab member 82 is freed from being at least partially engaged within and retained by the recess member 84.

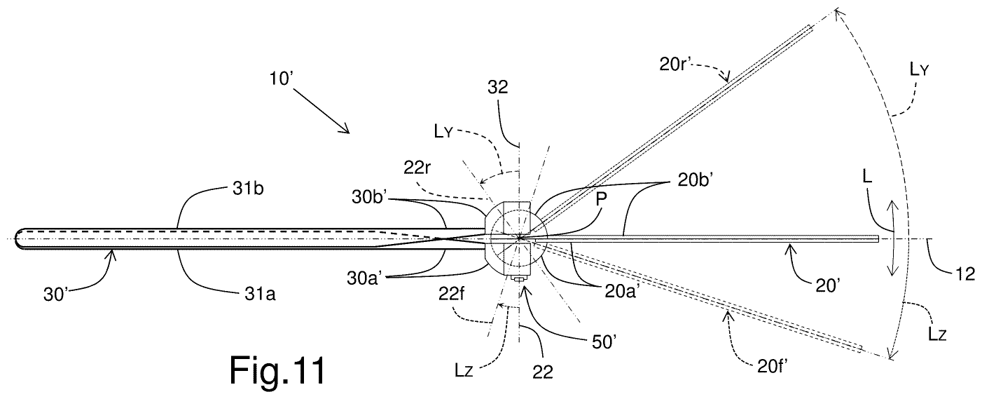

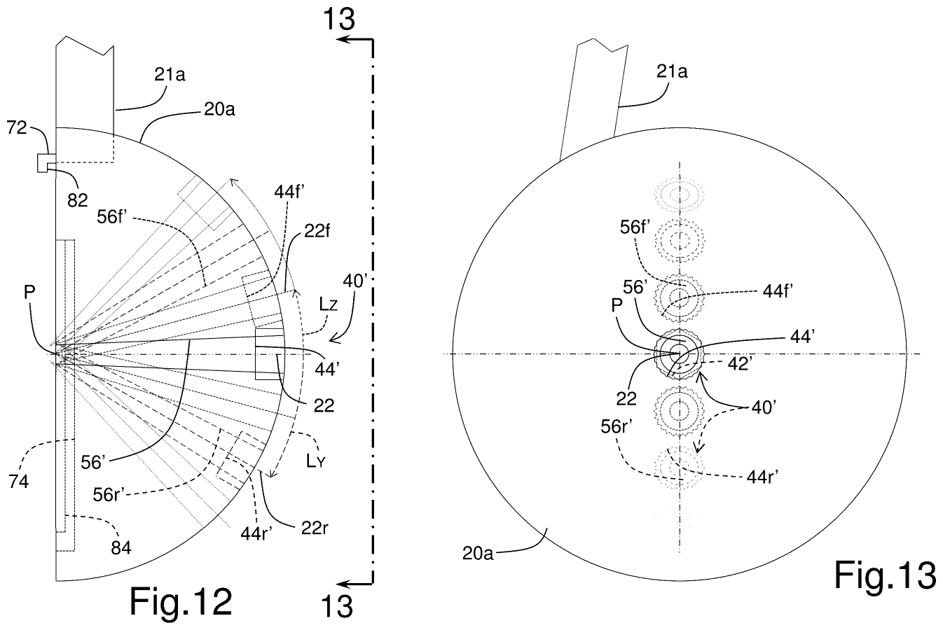

In another embodiment 10′ illustrated in FIGS. 11 to 15, the main axis 22 is angularly spaced relative to the handle axis 32, thereby defining a lateral (shift—transversal) angle L therebetween, and the intersection point P is a mid-point between the first 20a′ and second 20b′ working members 20′. As best seen in FIG. 11, the connecting member 40′, and retaining member 50′, allows a selective lateral angular, defined as main angle L, positioning of the main axis 22 relative to the handle axis 32, for example, with the pair of working members 20r′ being angularly moved rearward (or counter-clockwise—seen as upward in FIG. 11—also represented with the long-dash-line hole part 44r′ in FIG. 12) by lateral angle L_{Y} of about 36°, or with the pair of working members 20f′ being angularly moved frontward (or clockwise—seen as downward in FIG. 11—also represented with the short-dash-line hole part 44f′ in FIG. 12) by lateral angle L_{Z} of about 18° relative to the pair of handle members 30′. This selective lateral angular positioning of the working members 20′ relative to the handle members 30′ makes the interface therebetween being at least partially hemi-spherical (three additional lateral positions, both for front and rear displacements, are schematically illustrated in FIGS. 12 and 13, with approximately 18° between two adjacent positions).

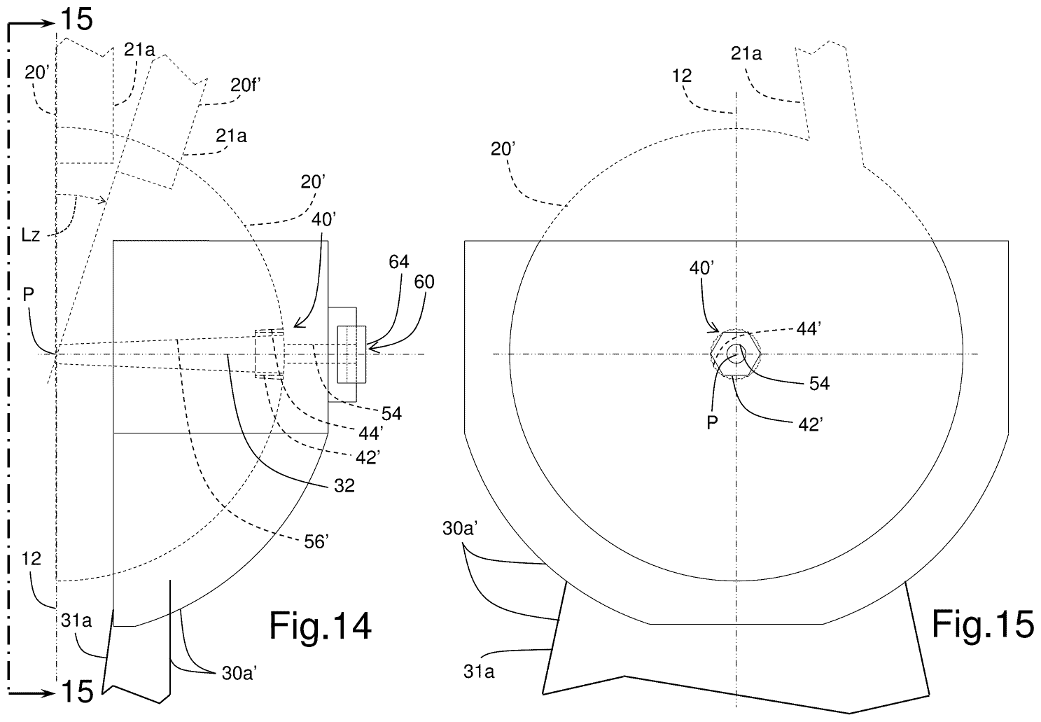

In this embodiment 10′, the connecting member 40′ typically allows for translational and/or rotational displacement between the first 30a′ and second 30b′ handle members 30′ and the respective first 20a′ and second 20b′ working members 20 connected thereto. Accordingly, as more specifically illustrated in FIGS. 12 and 14, each through-hole 56′, 56r′, 56f′ (and also each hole part 44′, 44r′, 44f′) typically tapers down in a direction extending toward the intersection point P (as best seen in FIG. 12), to allow for the lateral (“out-of-plane”) relative displacement there between, and this is why the lateral angle L typically should remain relatively small, such as 40° or less. The preferably uniform diameter of the rod (not shown) (and also the pin part 42′) is sized to fit the small diameter of the through-hole 56′, 56r′, 56f′ at the intersection point P (and also the small diameter size of the hole part 44′, 44r′, 44f′).

Because of the lateral shift of the working members 20′ relative to the handle members 30′, any move of the working members 20′ from the closed configuration to an open configuration will induce a slight variation of the position of the working members 20′ between the handle members 30′ along the handle axis 32, and this slight variation has to be accounted for, especially by the tapering of the through-hole 56′, 56r′, 56f′ and the hole part 44′, 44r′, 44f′ as well as the proper sizing thereof. Similarly, the retaining member 50, and especially the lock 60 might also need to be slightly modified or adjusted to account for the lateral angular displacements.

Although the second embodiment 10′ allows the selective lateral (front and rear) positioning of working members 20′ relative to the handle members 30′, it also allows, for each one of the selected lateral position, for the selective up and down positioning, as the first embodiment 10, but a person skilled in the art would readily understand that it could also not be the case, without departing from the scope of the present invention.

Although the present disclosure has been described with a certain degree of particularity and by way of an illustrative embodiment and examples thereof, it is to be understood that the present disclosure is not limited to the features of the embodiments described and illustrated herein, but includes all variations and modifications within the scope and spirit of the disclosure as hereinafter claimed.

1. A universal tool device for working out an object, the device comprising:
first and second working members pivotally connecting to one another about a main axis, the first and second working members being adapted to simultaneously work the object therebetween;
first and second handle members pivotally connecting to one another about a handle axis intersecting the main axis at least at an intersection point between the first and second working members, the first and second handle members connecting to the first and second working members, respectively, via a connecting member, the connecting member allowing a selective angular positioning about the main axis between the first and second handle members and the respective first and second working members; and
a retaining member selectively retaining the first and second handle members and the respective first and second working members connected to one another along the main axis.

2. The device of claim 1, wherein the first and second handle members removably connecting to the first and second working members, respectively.

3. The device of claim 2, wherein the handle axis being colinear with the main axis.

4. The device of claim 3, wherein the first and second working members being removably connected to one another.

5. The device of claim 1, wherein the first and second working members including a guide mechanism allowing the first and second working members to pivot relative to one another about the main axis between a fully open configuration, in which the first and second working members are adapted to receive the object therebetween, and a closed configuration, in which the first and second working members abut to one another with no object therebetween.

6. The device of claim 5, further including a securing mechanism axially securing the first and second working members to one another along the main axis while allowing the first and second working members to pivot relative to one another about the main axis.

7. The device of claim 5, wherein the guide mechanism including a symmetrical pin and slot arrangement with a slot portion being arcuate about the main axis for slidably receiving a respective pin portion therealong.

8. The device of claim 6, wherein the securing mechanism including a tab member radially protruding from the respective pin portion for engaging a recess member radially extending from the respective slot portion.

9. The device of claim 2, wherein the connecting member includes a pin part extending from each said first and second handle members toward the other one said first and second handle members engaging a corresponding hole part extending into each said first and second working members, each said pin part axially extending along the handle axis and each said hole part axially extending along the main axis.

10. The device of claim 9, wherein each said pin part and said hole part having a generally axial elongated body and corresponding and recess, respectively, with a transversal section area of a polygonal shape.

11. The device of claim 10, wherein the polygonal shape is one of a triangular, a square, an hexagonal, an heptagonal, an octagonal, a nonagonal, a decagonal, an hendecagonal, a dodecagonal, an hexadecagonal, an icosagonal, and a icositetragonal shape.

12. The device of claim 2, wherein the retaining member including a rod member extending from one said first and second handle members towards the other one said first and second handle members, and a lock member located at a free end of the rod member releasably securing to the other one said first and second handle members.

13. The device of claim 12, wherein the rod member extending along the main axis and through the first and second working members.

14. The device of claim 12, wherein the lock being a circumferential slot extending radially inwardly at the free end of the rod member and being selectively engageable by a locking tab member movably mounted on the other one said first and second handle members.

15. The device of claim 2, wherein the handle axis is angularly spaced relative to the main axis, thereby defining a lateral angle therebetween, and the intersection point is a mid-point between the first and second working members.

16. The device of claim 15, wherein the connecting member allowing for translational and/or rotational displacement between the first and second handle members and the respective first and second working members connected thereto.

17. The device of claim 16, wherein the connecting member includes a pin part extending from each said first and second handle members toward the other one said first and second handle members engaging a corresponding hole part extending into each said first and second working members, each said pin part axially extending along the handle axis and each said hole part axially extending along the main axis.

18. The device of claim 17, wherein each said pin part and said hole part tapering down in a direction extending toward the intersection point.
